(19) United States
(12) Patent Application Publication
(10) Pub. No.: US 2005/0088095 A1
(43) Pub. Date: Apr. 28, 2005

(54) Plasma display panel provided with an improved protective layer

(76) Inventor: Ki-Dong Kim, Suwon-si (KR)

Correspondence Address: MCGUIREWOODS, LLP, 1750 TYSONS BLVD, SUITE 1800, MCLEAN, VA, 22102, US

(21) Appl. No.: 10/969,855

(22) Filed: Oct. 22, 2004

(30) Foreign Application Priority Data
Oct. 24, 2003 (KR) 10-2003-0074670

(51) Int. Cl. H01J 17/49

(52) U.S. Cl. 313/586; 313/582; 313/587

(57) ABSTRACT

A plasma display panel (PDP) includes a first substrate and a second substrate opposing one another with a predetermined gap therebetween. The PDP also includes first electrodes formed on a surface of the first substrate opposing the second substrate, and second electrodes formed on a surface of the second substrate opposing the first substrate. Long axes of the first electrodes intersect those of the second electrodes. Also included in the PDP are dielectric layers. One dielectric layer is formed covering the first electrodes on the first substrate, and another dielectric layer is formed covering the second electrodes on the second substrate. There is further included an MgO protection layer that is formed covering the dielectric layer on the first substrate. A crystalline orientation planes of the MgO protection layer are produced by mixing (111) planes and (110) planes, and a mixing ratio of the (111) planes and the (110) planes is settled according to a grain size of the MgO protection layer.

### CROSS-REFERENCE TO RELATED APPLICATIONS

The present application claims priority to Korean patent application No. 2003-0074670 filed in the Korean Intellectual Property Office on Oct. 24, 2003, the entire contents of which are herein incorporated by reference in their entirety.

### BACKGROUND OF THE INVENTION

1. Field of the Invention

The present invention relates to a plasma display panel (hereinafter referred to as a “PDP”), and more particularly, to a PDP having an improved protective layer.

2. Description of the Related Art

A PDP is a display device that uses light emitted from plasma, which is generated during gas discharge, to display characters and graphics. Predetermined voltages are applied to two different types of electrodes mounted in a discharge area of the PDP to generate a plasma discharge between the electrodes; and ultraviolet rays generated during the plasma discharge excite phosphor layers formed in predetermined patterns on a surface of a discharge cell to thereby produce the display of images.

Several different categories of PDPs include the AC PDP, the DC PDP, and the hybrid PDP. FIG. 8 is a partially exploded perspective view of a discharge cell of a conventional AC type PDP. With reference to FIG. 8, a conventional PDP 100 includes a lower substrate 111 and various elements formed on the lower substrate 111, and an upper substrate 113 and various elements formed thereon. With respect to the lower substrate 111, a plurality of address electrodes 115 are formed on a surface of the lower substrate 111 opposing the upper substrate 113. A dielectric layer 119 is formed on the lower substrate 111 covering the address electrodes 111, and a plurality of barrier ribs 123 are formed on the dielectric layer 119. The barrier ribs 123 maintain a discharge distance and prevent crosstalk. Phosphor layers 125 are formed on exposed, inside surfaces of the barrier ribs 123.

The upper substrate 113 is provided opposing the lower substrate 111 with a predetermined gap therebetween. A plurality of discharge sustain electrodes 117 is formed on a surface of an upper substrate 113 opposing the lower substrate 111. The long axes of the discharge sustain electrodes 117 are substantially perpendicular to those of the address electrodes 115. Furthermore, a dielectric layer 121 is formed on the upper substrate 113 covering the discharge sustain electrodes 117, and a protection layer 127 is formed on the dielectric layer 121. MgO is typically used for the protection layer 127. MgO is not only transparent to allow visible light to be easily transmitted therethrough, but has excellent dielectric layer protection and secondary electron emission properties.

The MgO protection layer is a thin and transparent layer that has sputtering resistance characteristics to thereby minimize the affect of ion bombardment of discharge gas that occurs during discharge that occurs during PDP operation. As a result, the MgO protection layer protects the dielectric layer from ion collisions and acts to reduce a discharge voltage through secondary electron emission. The MgO protection layer covers the dielectric layer of a PDP while being formed to a thickness of 3000˜7000 Å.

The MgO protection layer may be formed using various methods such as sputtering, electron beam deposition, IBAD (ion beam assisted deposition), CVD (chemical vapor deposition), and sol-gel method. A relatively new method referred to as ion plating is also being used.

In electron beam deposition, electron beams accelerated by electric fields and magnetic fields strike an MgO deposition material to heat and evaporate the deposition material. An MgO protection layer is formed through this process. The sputtering method permits the manufacture of a protection layer that is more densely formed and is much easier to form a crystalline orientation when compared to the protection layer formed using electron beam deposition. However, unit cost for the protection layer is high when using the sputtering method. The MgO protection layer may also be produced from a liquid in the sol-gel method.

Ion plating has been developed as an alternative to the above various methods of forming the MgO protection layer. In ion plating method, evaporated particles are ionized to form a layer. Although the adhesivity and crystallinity of the MgO protection layer formed using ion plating are similar to those developed using the sputtering method, ion plating has the advantage of realizing high deposition speeds of approximately 8 nm/s.

A single crystal MgO or a sintered MgO may also be used. In the case of the single crystal MgO, as a result of the differences in solid solution limitations caused by cooling speeds during fusion to produce deposition, it is difficult to control a suitable quantity of a specific dopant. Therefore, the MgO protection layer is manufactured by ion plating using a sintered MgO having added thereto a suitable quantity of a specific dopant.

Since the MgO protection layer contacts discharge gas, the elements comprised in the protection layer and layer characteristics greatly affect discharge characteristics. MgO protection layer characteristics depend on, to a great extent, its elements and layer forming conditions during deposition. Accordingly, there is an urgent need to produce the formation of an MgO protection layer that improves the display quality of PDPs by developing optimal protection layer deposition conditions that improve desired layer characteristics.

### SUMMARY OF THE INVENTION

In one exemplary embodiment of the present invention, a plasma display panel includes an MgO protective layer having improved material properties and operating characteristics. In another exemplary embodiment of the present invention, a plasma display panel includes an optimal crystalline orientation plane of an MgO protection layer that improves the operating characteristics of the same.

In an exemplary embodiment, a PDP includes a first substrate and a second substrate opposing one another with a predetermined gap therebetween. The PDP also includes first electrodes formed on a surface of the first substrate opposing the second substrate, and second electrodes formed on a surface of the second substrate opposing the first substrate. Long axes of the first electrodes intersect long axes of the second electrodes. Also included in the PDP are dielectric layers. One dielectric layer may be formed covering the first electrodes on the first substrate, and another dielectric layer may be formed covering the second electrodes on the second substrate. There is further included an MgO protection layer that may be formed covering the dielectric layer on the first substrate. A crystalline orientation plane of the MgO protection layer may be optimized by mixing (111) planes and (110) planes. Additionally, a mixing ratio of the (111) planes and the (110) planes may be determined based on a grain size of the MgO protection layer.

In an exemplary embodiment of the present invention, if the grain size of the MgO protection layer is in the range of approximately 50 nm to approximately 100 nm, the (111) planes and the (110) planes may be mixed in a ratio of (5.5 to 6.5) to (3.5 to 4.5).

In another exemplary embodiment of the present invention, if the grain size of the MgO protection layer is approximately 100 nm to approximately 150 nm, the (111) planes and the (110) planes may be mixed in a ratio of (4.5 to 5.5) to (4.5 to 5.5).

In yet another exemplary embodiment of the present invention, if the grain size of the MgO protection layer is in the range of approximately 150 nm to approximately 200 nm, the (111) planes and the (110) planes may be mixed in a ratio of (3.0 to 4.0) to (6.0 to 7.0).

In still yet another exemplary embodiment of the present invention, if the grain size of the MgO protection layer is in the range of approximately 200 nm to approximately 250 nm, the (111) planes and the (110) planes may be mixed in a ratio of (2.5 to 3.5) to (6.5 to 7.5).

In still yet another exemplary embodiment of the present invention, if the grain size of the MgO protection layer is in the range of approximately 250 nm to approximately 350 nm, the (111) planes and the (110) planes may be mixed in a ratio of (1.5 to 2.5) to (7.5 to 8.5).

Preferably, the MgO protection layer has a columnar crystal structure.

Furthermore, a grain size of the MgO protection layer may be settled by controlling a partial pressure ratio of hydrogen and oxygen, respectively.

### BRIEF DESCRIPTION OF THE DRAWINGS

The accompanying drawings, which together with the specification, illustrate exemplary embodiments of the present invention, and, together with the description, serve to explain the principles of the present invention.

FIG. 1 is a perspective view of an upper substrate of a PDP according to an exemplary embodiment of the present invention.

FIG. 2 is a schematic view showing an MgO deposition process according to an exemplary embodiment of the present invention.

FIG. 3 is a photograph of a surface of an MgO protection layer according to a first embodiment of the present invention, in which the photograph is taken using a scanning electron microscope (hereinafter referred to as “SEM”).

FIG. 4 is a photograph of a surface of an MgO protection layer according to a second embodiment of the present invention, in which the photograph is taken using an SEM.

FIG. 5 is a photograph of a surface of an MgO protection layer according to a third embodiment of the present invention, in which the photograph is taken using an SEM.

FIG. 6 is a photograph of a surface of an MgO protection layer according to a fourth embodiment of the present invention, in which the photograph is taken using an SEM.

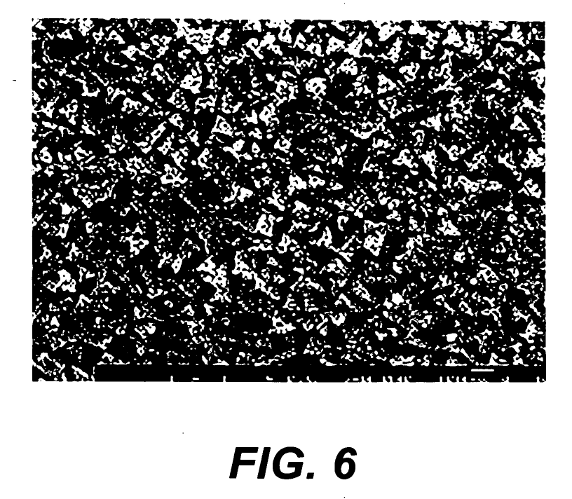

FIG. 7 is a photograph of a surface of an MgO protection layer according to a fifth embodiment of the present invention, in which the photograph is taken using an SEM.

FIG. 8 is a partially exploded perspective view of a discharge cell of a conventional AC PDP.

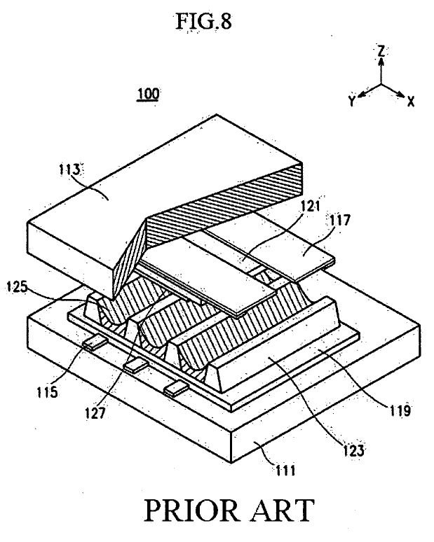

### DETAILED DESCRIPTION

Exemplary embodiments of the present invention will now be described in detail is with reference to the accompanying drawings.

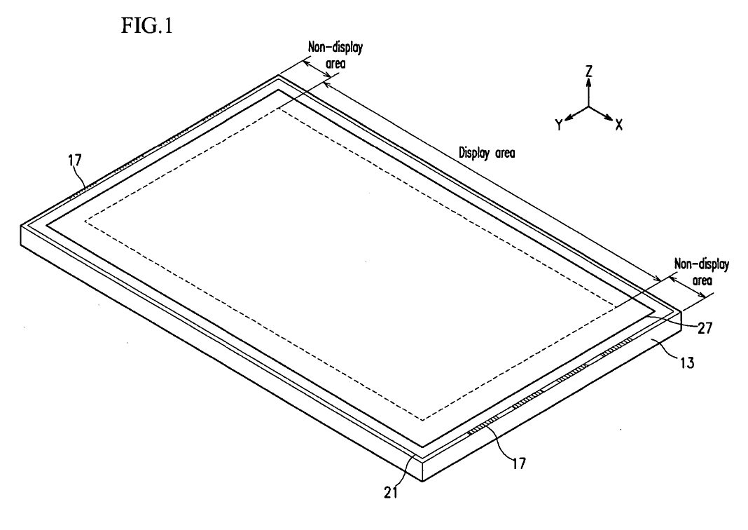

FIG. 1 is a perspective view of an upper substrate of a plasma display panel (PDP) according to an exemplary embodiment of the present invention. In FIG. 1, only an upper portion of the PDP has been left visible for viewing.

In FIG. 1, an upper substrate 13 and elements formed thereon are shown. In particular, (in this sequence) a plurality of electrodes 17, a dielectric layer 21, and a protection layer 27, may be formed on one surface of the upper substrate 13. For better viewing, the upper substrate 13 has been flipped over to show the side on which these elements are formed. Although not shown in FIG. 1, formed on a surface of a lower substrate opposing the upper substrate 13 are a plurality of different electrodes with long axes substantially perpendicular to long axes of the electrodes 17, a dielectric layer covering the electrodes, and barrier ribs formed on the dielectric layer. Phosphor layers are deposited between the barrier ribs.

A frit may be deposited along edges of opposing surfaces of the upper substrate and the lower substrate to seal the same. A discharge gas such as Ne or Xe may then be injected between the upper substrate and the lower substrate to thereby complete the PDP.

In the PDP according to an exemplary embodiment of the present invention described above, drive voltages may be received from the electrodes to thereby generate address discharge between the electrodes and form a wall charge in the dielectric layer. Also, in discharge cells selected by address discharge, a sustain discharge may be effected between a pair of electrodes formed on the upper substrate by an AC signal supplied alternately to the electrodes. Accordingly, the discharge gas contained in a discharge area having one or more discharge cells generates ultraviolet rays while being excited by the AC signal. The ultraviolet rays excite phosphors of the phosphor layers formed on a surface of the respective discharge cells to thereby produce the display of images.

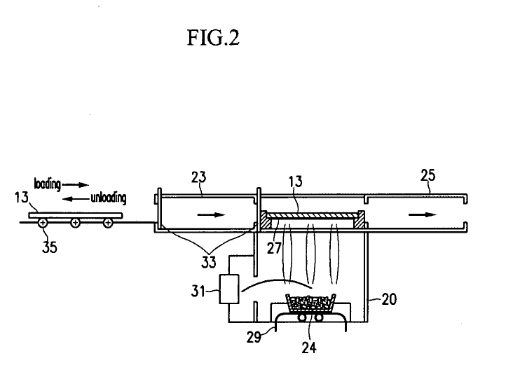

FIG. 2 is a drawing schematically showing processes involved in forming an MgO protection layer using MgO pellets according to an exemplary embodiment of the present invention. An example of electron beam deposition is shown in which an MgO protection layer is formed on a substrate following the sequential formation of electrodes and a dielectric layer on the substrate.

In the processes according to an exemplary embodiment of the present invention, electron beams accelerated by an electric field and a magnetic field strike a deposition material to heat and evaporate the deposition material and thereby form a protection layer. Energy of the electron beams is concentrated on a surface of the material to thereby produce high speed and high purity deposition. It is to be noted that FIG. 2 shows only one example of the processes involved in forming the protection layer, and the present invention is not limited to the processes shown and described.

In the layer forming processes of the MgO protection layer 27 shown in FIG. 2, the substrate 13 is moved through the processes starting from one point and ending at another point by rollers 35. In the drawing, the substrate 13 is moved from left to right. The substrate 13 is first loaded into a deposition chamber inlet port 23. Following deposition of the MgO protection layer 27, the substrate 13 is discharged into a deposition chamber output port 25. The substrate 13 may be unloaded from the deposition chamber inlet port 23 if there are any problems with the substrate 13. Since a vacuum must be formed in a deposition chamber 20, a vacuum pump (not shown) is provided that continuously performs evacuation of air from the chamber 20. Also, an interior of the deposition chamber 20 is isolated from an exterior of the same using a pair of shutters 33 that open and close the deposition chamber 20. An electron gun 31 is operated to generate an electric field and a magnetic field. Electron beams emitted from the electron gun 31 bombard MgO pellets 24, which are positioned at a lower area of the deposition chamber 20 and are used as the deposition material, such that the MgO is deposited on the substrate 13 positioned above the MgO pellets 24. An interior atmosphere of the deposition chamber 20 is controlled through the supply of hydrogen and oxygen to vary the partial pressure ratio of hydrogen and oxygen. Since the MgO pellets 24 can be overheated due to ion collisions, a cooling device 29 is provided so that the MgO protection layer 27 is deposited while a cooling operation is performed.

The protection layer in a PDP may contact a discharge gas. As a result, the elements comprised in the protection layer and layer characteristics greatly affect discharge characteristics. Especially, the MgO protection layer affects a discharge delay time. The discharge delay time may illustratively be described as follows. The time during which a drive voltage is applied to the PDP through scanning electrodes is referred to as a scanning time. Although discharge occurs during the scanning time, in practice, discharge does not immediately occur at the instant the drive voltage is applied and instead is delayed. This is referred to as discharge delay time. The discharge delay time is divided into a formation delay time and a statistical delay time.

In the present invention, a crystalline orientation plane of the MgO protection layer used in the PDP is adjusted by varying deposition conditions, and the resulting discharge delay time is measured. This is done in an effort to determine the crystalline orientation plane resulting in the shortest discharge delay time. To produce this in the present invention, a partial pressure ratio of hydrogen and oxygen was varied to deposit the MgO protection layer, and changes in the crystalline orientation plane were observed. The MgO protection layer according to an exemplary embodiment of the present invention is deposited while varying a partial pressure ratio of hydrogen and oxygen to obtain crystalline orientation planes listed in Table 1 below. Corresponding statistical delay times also appear in Table 1.

TABLE 1

| | Crystalline orientation planes | Statistical delay time (ns) |
|---|---|---|
| 1 | (111) | 437˜641 |
| 2 | (110) | 285˜332 |
| 3 | (111) & (110) | 255˜316 |
| 4 | (200) | 462˜570 |
| 5 | (311) | 553˜682 |

The information illustrated by Table 1 is exemplary and should not be understood as limiting the invention. Other embodiments may use other mixing ratios and/or provide other statistical delay times. As shown in Table 1, in the case where the crystalline orientation planes are a combination of the (111 ) planes and the (110) planes for the MgO protection layer of the PDP, the shortest statistical delay time of approximately 255 ns to approximately 316 ns results. Hence, the best discharge characteristics may be obtained when the surface of the MgO protection layer, which has a columnar crystal structure, is a combination of the (111) planes and the (110) planes.

The grain size of the MgO protection layer may be adjusted by adjusting the oxygen/hydrogen partial pressure ratio, and the mixing ratio of the (111) planes and the (110) planes may be settled according to grain size. For example, in the case where only oxygen is injected without hydrogen when depositing the MgO protection layer using ion plating method, a crystalline orientation plane of the protection layer surface results in a (111) plane. If hydrogen is gradually injected to increase the partial pressure of oxygen and hydrogen, the grain size of the MgO protection layer may be slowly increased. Then, if the partial pressure ratio of hydrogen and oxygen reaches a certain critical value, the (110) crystalline orientation plane begins to be produced. Furthermore, if the partial pressure ratio of hydrogen with respect to oxygen exceeds the critical value, the (111) plane disappears and the crystalline orientation plane are changed into (110) planes. In addition, the grain size may be controlled according to the partial pressure ratio of hydrogen and oxygen. In the above MgO protection layer formation process, a gradual reduction in the grain size was observed.

The following experiments were performed in exemplary embodiments of the present invention to more carefully observe these phenomena. An explanation of these exemplary embodiments is provided below. It is to be noted that the exemplary embodiments that follow merely illustrate the present invention are not meant to be restrictive. In the exemplary embodiments of the present invention, a grain size and a crystalline orientation plane of the MgO protection layer may be defined by controlling partial pressures of injected oxygen and hydrogen. However, the method of using partial pressures of oxygen and hydrogen as a variable parameter is just one of examples of adjusting crystalline orientation planes, and it is possible to produce changes in the crystalline orientation plane through other means.

### Exemplary Embodiment 1

MgO pellets were placed in an MgO deposition chamber, and MgO was deposited on a PDP on which a dielectric layer had been formed. The resulting MgO protection layer was formed to a thickness of approximately 7000 Å. A standard pressure inside the deposition chamber was set at 1×10⁻⁴ Pa, and a pressure during deposition was set at 5.3×10⁻² Pa. Also, the substrate was maintained at 200±5° C. while supplying oxygen at a rate of 100 sccm. Electron beams were irradiated from an electron gun set at a current of 390 mA and a voltage of −15 kV to deposit the MgO protection layer. A partial pressure ratio of hydrogen and oxygen was set at approximately 6:1, and the grain size of the MgO protection layer was made to be approximately 250 nm to approximately 350 nm. Accordingly, the statistical delay times were measured while varying a mixing ratio of the (111) planes to the (110) planes. The results are shown in Table 2 below.

TABLE 2

| | Mixing ratio of (111) planes to (110) | |
|---|---|---|
| | planes | Statistical delay time (ns) |
| 1 | 1:9 | 351˜372 |
| 2 | 2:8 | 282˜295 |
| 3 | 3:7 | 323˜331 |
| 4 | 4:6 | 325˜343 |
| 5 | 5:5 | 381˜404 |

The information illustrated by Table 2 is exemplary and should not be understood as limiting the invention. Other embodiments may use other mixing ratios and/or provide other statistical delay times. As shown in Table 2, when the grain size of the MgO protection layer is 250 nm to 350 nm and the ratio of the (111) planes to the (110) planes of the MgO protection layer is determined through visual observation to be about 2:8, the statistical delay time was the shortest. It was determined through more precise testing that the optimal range of the ratio of these planes is 1.5 to 2.5 for the (111) planes to 7.5 to 8.5 for the (110) planes.

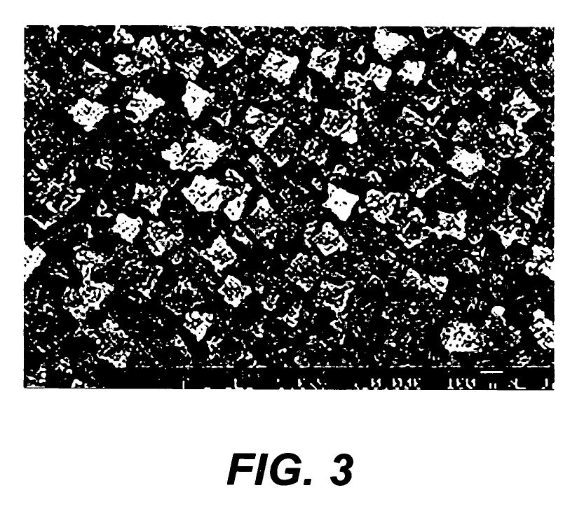

FIG. 3 is a photograph of a surface of the MgO protection layer according to Exemplary Embodiment 1 of the present invention, that represents a picture was taken of the MgO protection layer using an SEM. In the SEM picture of FIG. 3, the quadrilateral-like shapes indicate (110) planes among the crystalline orientation planes, while the triangular-like shapes indicate (111) planes. FIG. 3 is a partial view of the SEM picture according to Exemplary Embodiment 1 of the present invention. It may be observed that Exemplary Embodiment 1 produces mostly (110) planes in the protection layer that are roughly quadrilateral in shape.

### Exemplary Embodiment 2

In this embodiment, the partial pressure ratio of hydrogen and oxygen was adjusted to approximately 3:1 to produce an MgO protection layer with a grain size of 200 nm to 250 nm. Therefore, the mixing ratio of the (111) planes to the (110) planes was settled, and the statistical delay times were measured. The results are shown in Table 3 below.

TABLE 3

| | Mixing ratio of (111) planes to (110) | |
|---|---|---|
| | planes | Statistical delay time (ns) |
| 1 | 1:9 | 403˜414 |
| 2 | 2:8 | 335˜346 |
| 3 | 3:7 | 253˜292 |
| 4 | 4:6 | 282˜331 |
| 5 | 5:5 | 323˜334 |

The information illustrated by Table 3 is exemplary and should not be understood as limiting the invention. Other embodiments may use other mixing ratios and/or provide other statistical delay times. As shown in Table 3, when the grain size of the MgO protection layer was approximately 200 nm to approximately 250 nm and the ratio of the (111) planes to the (110) planes of the MgO protection layer was determined through visual observation to be about 3:7, the statistical delay time was the shortest. It was determined through more precise testing that the one optimal range of the ratio of these planes is may be 2.5 to 3.5 for the (111) planes to 6.5 to 7.5 for the (110) planes.

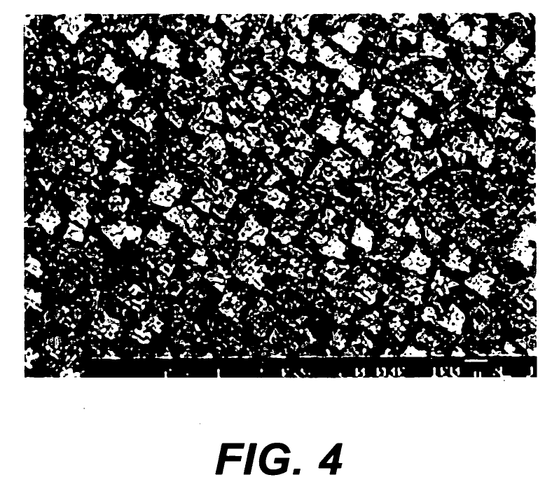

FIG. 4 is a photograph of a surface of the MgO protection layer according to Exemplary Embodiment 2 of the present invention taken using an SEM. It may be observed that Exemplary Embodiment 2 produces mostly (110) planes in the protection layer that are roughly quadrilateral in shape.

### Exemplary Embodiment 3

The partial pressure ratio of hydrogen and oxygen was adjusted to approximately 2.5:1 to produce an MgO protection layer with a grain size of approximately 150 nm to 200 nm. Therefore, the mixing ratio of the (111) planes to the (110) planes was settled, and the statistical delay times were measured. The results are shown in Table 4 below. The remaining conditions were identical to those of Experimental Example 1.

TABLE 4

| | Mixing ratio of (111) planes to (110) | |
|---|---|---|
| | planes | Statistical delay time (ns) |
| 1 | 1.5:8.5 | 381˜412 |
| 2 | 2.5:7.5 | 323˜332 |
| 3 | 3.5:6.5 | 271˜283 |
| 4 | 4.5:5.5 | 352˜357 |
| 5 | 5.5:4.5 | 361˜383 |

The information illustrated by Table 4 is exemplary and should not be understood as limiting the invention. Other embodiments may use other mixing ratios and/or provide other statistical delay times. As shown in Table 4, when the grain size of the MgO protection layer is approximately 150 nm to 200 nm and the ratio of the (111) planes to the (110) planes of the MgO protection layer is determined through visual observation to be about 3.5:6.5, the statistical delay time may be the shortest. It was determined through more precise testing that an optimal range of the ratio of these planes may be about 3.0 to 4.0 for the (111) planes to about 6.0 to 7.0 for the (110) planes.

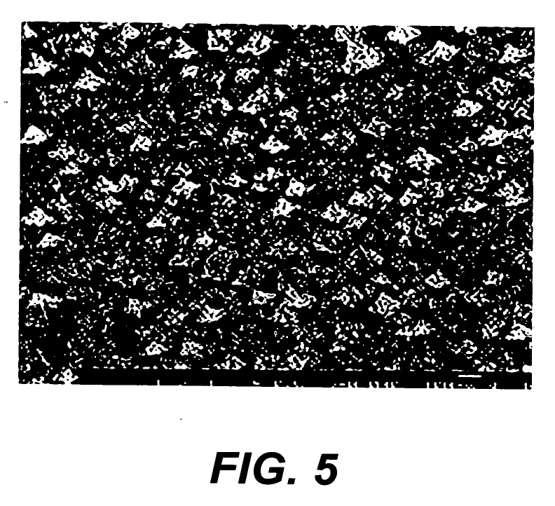

FIG. 5 is a photograph of a surface of the MgO protection layer according to Exemplary Embodiment 3 of the present invention taken using an SEM. It may be observed that Exemplary Embodiment 3 produces in the protection layer mostly (110) planes that are roughly quadrilateral in shape result, as well as a smaller number of (111) planes that are roughly triangular in shape.

### Exemplary Embodiment 4

In this embodiment, the partial pressure of hydrogen and oxygen was adjusted to produce an MgO protection layer with a grain size of approximately 100 nm to approximately 150 nm. Therefore, the mixing ratio of the (111) planes to the (110) planes was determined, and the statistical delay times were measured. The results are shown in Table 5 below. The remaining conditions were identical to those of Experimental Example 1.

TABLE 5

| | Mixing ratio of (111) planes to (110) | |
|---|---|---|
| | planes | Statistical delay time (ns) |
| 1 | 3:7 | 346˜372 |
| 2 | 4:6 | 311˜327 |
| 3 | 5:5 | 263˜277 |
| 4 | 6:4 | 314˜333 |
| 5 | 7:3 | 343˜374 |

The information illustrated by Table 5 is exemplary and should not be understood as limiting the invention. Other embodiments may use other mixing ratios and/or provide other statistical delay times. As shown in Table 5, when the grain size of the MgO protection layer is approximately 100 nm to approximately 150 nm and the ratio of the (111) planes to the (110) planes of the MgO protection layer is determined through visual observation to be about 5:5, the statistical delay time may be the shortest. It was determined through more precise testing that an optimal range of the ratio of these planes may be 4.5 to 5.5 for the (111) planes, and 4.5 to 5.5 for the (110) planes.

FIG. 5 is a photograph of a surface of the MgO protection layer according to Exemplary Embodiment 4 of the present invention taken using an SEM. It may be observed that (110) planes that are roughly quadrilateral in shape and (111) planes that are roughly triangular in shape are evenly mixed in the protection layer.

### Exemplary Embodiment 5

In this embodiment, the partial pressure of hydrogen and oxygen was adjusted to produce an MgO protection layer with a grain size of approximately 50 nm to 100 nm. Therefore, the mixing ratio of the (111) planes to the (110) planes was determined, and the statistical delay times were measured. The results are shown in Table 6 below. The partial pressure of hydrogen was adjusted to a minimal level. The remaining conditions were identical to those of Experimental Example 1.

TABLE 6

| | Mixing ratio of (111) planes and (110) | |
|---|---|---|
| | planes | Statistical delay time (ns) |
| 1 | 4:6 | 351˜381 |
| 2 | 5:5 | 301˜322 |
| 3 | 6:4 | 253˜271 |
| 4 | 7:3 | 314˜326 |
| 5 | 8:2 | 341˜382 |

The information illustrated by Table 6 is exemplary and should not be understood as limiting the invention. Other embodiments may use other mixing ratios and/or provide other statistical delay times. As shown in Table 6, when the grain size of the MgO protection layer is approximately 50 nm to approximately 100 nm and the ratio of the (111) planes to the (110) planes of the MgO protection layer is determined through visual observation to be about 6:4, the statistical delay time may be the shortest. It was determined through more precise testing that an optimal range of the ratio of these planes may be 5.5 to 6.5 for the (111) planes and 3.5 to 4.5 for the (110) planes.

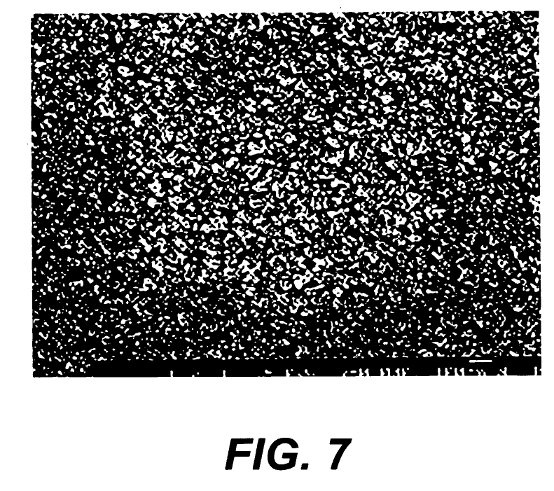

FIG. 7 is a photograph of a surface of the MgO protection layer according to Exemplary Embodiment 5 of the present invention taken using an SEM. It may be observed that Exemplary Embodiment 5 provides in the protection layer mostly (111) planes that are roughly triangular in shape.

In the present invention described above, the crystalline orientation plane of the MgO protection layer may be altered by mixing the ratios of (111) planes and (110) planes. The mixing ratio of these crystalline planes is settled at specific grain sizes to improve electron emission performance and to improve the display quality of the PDP.

In addition, by fixing the mixing ratio of the (111) planes and the (110) planes at various grain sizes, discharge characteristics are improved and the discharge delay time is reduced. The generation of black noise may also be reduced as a result.

Although embodiments of the present invention have been described in detail hereinabove in connection with certain exemplary embodiments, it should be understood that the invention is not limited to the disclosed exemplary embodiments, but, on the contrary is intended to cover various modifications and/or equivalent arrangements included within the spirit and scope of the present invention, as defined in the appended claims.

1. A plasma display panel, comprising:
a first substrate and a second substrate opposing one another with a predetermined gap therebetween;
first electrodes formed on a surface of the first substrate opposing the second substrate, and second electrodes formed on a surface of the second substrate opposing the first substrate, long axes of the first electrodes intersecting long axes of the second electrodes;
dielectric layers, one of which is formed covering the first electrodes on the first substrate and another of which is formed covering the second electrodes on the second substrate; and
an MgO protection layer formed covering the first dielectric layer on the first substrate,
wherein a crystalline orientation planes of the MgO protection layer are produced by mixing (111) planes and (110) planes, and a mixing ratio of the (111) planes and the (110) planes is settled according to a grain size of the MgO protection layer.

2. The plasma display panel of claim 1, wherein if the grain size of the MgO protection layer is 50 nm to 100 nm, the (111) planes and the (110) planes are mixed in a ratio of (5.5 to 6.5):(3.5 to 4).

3. The plasma display panel of claim 1, wherein if the grain size of the MgO protection layer is 100 nm to 150 nm, the (111) planes and the (110) planes are mixed in a ratio of (4.5 to 5.5):(4.5 to 5.5).

4. The plasma display panel of claim 1, wherein if the grain size of the MgO protection layer is 150 nm to 200 nm, the (111) planes and the (110) planes are mixed in a ratio of (3.0 to 4.0):(6.0 to 7.0).

5. The plasma display panel of claim 1, wherein if the grain size of the MgO protection layer is 200 nm to 250 nm, the (111) planes and the (110) planes are mixed in a ratio of (2.5 to 3.5):(6.5 to 7.5).

6. The plasma display panel of claim 1, wherein if the grain size of the MgO protection layer is 250 nm to 350 nm, the (111) planes and the (110) planes are mixed in a ratio of (1.5 to 2.5):(7.5 to 8.5).

7. The plasma display panel of claim 1, wherein the MgO protection layer has a columnar crystal structure.

8. The plasma display panel of claim 1, wherein the grain size of the MgO protection layer is determined according to a partial pressure ratio of hydrogen and oxygen injected during the deposition process of the MgO protection layer.

9. A method of forming a protection layer, comprising the steps of:
positioning a substrate proximate a deposition material within a deposition chamber;
accelerating one or more electron beams within an electric field and a magnetic field to strike the deposition material to heat and evaporate the deposition material such that atoms of the deposition material are deposited on a surface of the substrate to form a protection layer; and
adjusting a crystalline orientation plane of the protection layer by varying deposition conditions.

10. The method of claim 9, wherein the deposition material is MgO.

11. The method of claim 10, wherein the adjusting step further comprises controlling an inner atmosphere of the deposition chamber through a supply of hydrogen and oxygen to vary a partial pressure ratio of the hydrogen and oxygen.

12. The method of claim 10, wherein the adjusting step further comprises varying a partial pressure ratio of hydrogen and oxygen supplied to the deposition chamber to obtain the crystalline orientation plane which is a combination of (111) planes and (110) planes and which has a statistical discharge delay time of 255 ns to 315 ns.

13. The method of claim 10, wherein the adjusting step further comprises varying a partial pressure ratio of hydrogen and oxygen supplied to the deposition chamber to obtain the crystalline orientation plane which has a grain size in a range of about 250 nm to 350 nm and a statistical discharge delay time of about 282 ns to 295 ns,
wherein a ratio of (111) planes to (110) planes is about 2:8.

14. The method of claim 10, wherein the adjusting step further comprises varying a partial pressure ratio of hydrogen and oxygen supplied to the deposition chamber to obtain the crystalline orientation plane which has a grain size in a range of about 200 nm to 250 nm and a statistical discharge delay time of about 253 ns to 292 ns,
wherein a ratio of (111) planes to (110) planes is about 3:7.

15. The method of claim 10, wherein the adjusting step further comprises varying a partial pressure ratio of hydrogen and oxygen supplied to the deposition chamber to obtain the crystalline orientation plane which has a grain size in a range of about 150 nm to 200 nm and a statistical discharge delay time of 271 ns to 283 ns,
wherein a ratio of (111) planes to (110) planes is about 3.5:6.5.

16. The method of claim 10, wherein the adjusting step further comprises varying a partial pressure ratio of hydrogen and oxygen supplied to the deposition chamber to obtain the crystalline orientation plane which has a grain size in a range of about 100 nm to 150 nm and a statistical discharge delay time of 263 ns to 277 ns,
wherein a ratio of (111) planes to (110) planes is about 5:5.

17. The method of claim 10, wherein the adjusting step further comprises varying a partial pressure ratio of hydrogen and oxygen supplied to the deposition chamber to obtain the crystalline orientation plane which has a grain size in a range of about 50 nm to 100 mn and a statistical discharge delay time of 253 ns to 271 ns,
wherein a ratio of (111) planes to (110) planes is about 6:4.
